(19) United States
(12) Patent Application Publication
(10) Pub. No.: US 2009/0061137 A1
(43) Pub. Date: Mar. 5, 2009

(54) Coextruded, Heat-Sealable and Peelable Polyester Film

(76) Inventors: Matthias KONRAD, Hofheim (DE); Herbert PEIFFER, Mainz (DE); Gottfried HILKERT, Saulheim (DE)

Correspondence Address: PROPAT, L.L.C., 425-C SOUTH SHARON AMITY ROAD, CHARLOTTE, NC, 28211-2841, US

(21) Appl. No.: 12/199,945

(22) Filed: Aug. 28, 2008

(30) Foreign Application Priority Data
Sep. 3, 2007 (DE) 10 2007 041 706.5

(51) Int. Cl. B32B 33/00; B29C 49/08

(52) U.S. Cl. 428/41.3; 264/210.7

(57) ABSTRACT

The invention relates to a coextruded, peelable, and biaxially oriented polyester film with a base layer (B) and with at least one outer layer (A) applied to this base layer (B). The outer layer (A) is heat-sealable and features peelability with respect to nonpolar substrates, such as polystyrene (“PS”) and polypropylene (“PP”). The heat-sealable and peelable outer layer (A) includes a copolymer formed from ethylene and an acrylate. The invention further relates to a process for the production of the film and to packaging formed from the film.

### CROSS-REFERENCE TO RELATED APPLICATIONS

This application claims priority to German Patent Application No. 10 2007 041 706.5 filed Sep. 3, 2007 which is hereby incorporated herein by reference in its entirety.

### FIELD OF THE INVENTION

The invention relates to a coextruded, peelable, and biaxially oriented polyester film with a base layer (B) and with at least one outer layer (A) applied to this base layer (B). The outer layer (A) is heat-sealable and features peelability with respect to nonpolar substrates, such as polystyrene (“PS”) and polypropylene (“PP”). The heat-sealable and peelable outer layer (A) comprises a copolymer comprised of ethylene and of an acrylate. The invention further relates to a process for the production of the film and to the use of the film.

### BACKGROUND OF THE INVENTION

The food-and-drink industry makes wide use of packaging with peelable lids. The lids are intended not only to protect the contents from mechanical damage and contamination but also to be a barrier for gases such as oxygen and water vapor. Consumers must also find the lids easy to open, i.e. peelable. To achieve this end, the lids may include a layer which is heat-sealable and peelable.

In the prior art, the heat-sealable and peelable layer is generally applied to the polyester film by means known as “off-line methods” (i.e. in an additional process step, downstream of film production). This method begins by producing a “standard polyester film” by a conventional process. In a further step of processing, in a coating system, the resultant polyester film is then coated “off-line” with a heat-sealable and peelable layer. In this process, the heat-sealable and peelable polymer is first dissolved in an organic solvent. The finished solution is then applied to the film by way of a suitable application method (knife coater, screen roll, die). The solvent is evaporated in a downstream drying oven, and the peelable polymer remains as solid layer on the film.

This type of off-line application of the sealable layer is comparatively expensive, for a number of reasons. Firstly, the coating of the film has to take place in a separate step in a specific apparatus. Secondly, the solvent evaporated has to be recondensed and reclaimed, in order to minimize pollution of the environment by the exhaust air. Thirdly, high monitoring cost is incurred in order to ensure that the residual solvent content in the coating is minimized.

There is moreover no cost-effective method for complete removal of the solvent from the coating during the drying process, in particular because there is a limit to the time available for the drying procedure. Solvent traces remaining in the coating then migrate through the film located on the tray into the foods, where they can distort flavor or even adversely affect the health of consumers.

Various heat-sealable and peelable polyester films produced off-line are marketed. The polyester films differ in their structure and in the constitution of the outer layer (A).

There are some known films and laminates which seal with respect to substrates such as PS and PP.

DE-A-101 28 711 describes a coextruded sealable polyolefin film with an outer layer which comprises at least 70% by weight of a co- or terpolymer which is comprised of olefin and of unsaturated carboxylic acid or of esters thereof or of anhydride thereof. The adhesion of the film is described as good with respect to PP, PE, PET, PS, PVC, PC, glass, tin-plated steel, and aluminum. Particular disadvantages of polyolefin film in comparison with a PET film are poorer barrier with respect to oxygen, lower heat resistance, and poorer mechanical properties. By way of example, therefore, these films cannot be sealed at the industrially conventional temperatures of 160° C. and above.

U.S. Pat. No. 4,333,968 describes a polypropylene film which, after longitudinal orientation, is extrusion-coated with ethylene-vinyl acetate copolymer (EVA) and then transversely oriented. Another factor here in addition to the abovementioned disadvantages of polyolefin film is the low heat resistance of the EVA, such that excess film cannot be reground and reused.

WO 03/033258 describes a sealable and peelable lid-film laminate. The laminate is comprised of three layers, a layer of fibrous material (e.g. paper), a polymeric oxygen-barrier layer (PET, EVOH, and/or polyamide), and a sealable layer. The last two layers are, for example, coextruded and are laminated onto the first. The sealable layer is comprised of a combination of ethylene-methyl acrylate copolymer (EMA), EVA, and polyamide wax. The weight per unit area of the sealable layer is from 5 to 30 g/m², and it seals with respect to PE, PP and PS. The laminate is used as lid in food-and-drink packaging, e.g. for dairy products. The disadvantages of this laminate are not only the complicated production process but also, in comparison with PET film, poorer optical properties (luster) of the paper surface, and poorer printability. The laminate is moreover per se not recyclable.

WO 06/055656 relates to a sealable film or a laminate with a sealable film, where the sealable layer has an antifogging agent. The sealable layer of the film comprises or is comprised of an ethylene copolymer or a modified ethylene copolymer or both. The ethylene copolymer is a copolymer, a terpolymer, or a tetrapolymer which contains repeat units derived from ethylene and which contains from 5 to 50% by weight of one or more polar monomers selected from the group consisting of vinyl alkanoic acid, acrylic acid, α-alkyl acrylic acid, acrylic acid alkylester (=acrylate), and α-alkyl acrylate. The percentages by weight are based on the total amount of the ethylene copolymer or of the modified ethylene copolymer in the sealable layer.

The sealable layer, the film comprising the sealable layer and, respectively, the further layers can be manufactured by a number of processes not specified in any further detail, e.g. via the production of blown film, in-line or off-line by means of various coating processes or by means of coextrusion. Further layers mentioned are those produced from nylon, polypropylene, polyethylene, ionomers, polyethylene-vinyl acetate, polyethylene terephthalate, polystyrene, polyethylene-vinyl alcohol, polyvinylidene chloride, or a combination of two or more of these materials.

The examples cite laminates (thickness 63.5 μm) which are produced from two different types of film via adhesive lamination (not via coextrusion). The film support used comprises a PET film of thickness 12 μm and the sealable film used comprises a blown film comprised of 3 layers. The layers are comprised of HDPE, HDPE+LDPE, and modified EVA or EMA in the sealable layer. The laminate features high production costs, and is moreover not regrindable and therefore not environmentally compatible. The mechanical properties of the film/of the laminate (the film curls), and the thermal and optical properties (haze, luster) are moreover unsatisfactory (comprises cloudy HDPE).

EP-A-1 471 096, EP-A-1 471 097, EP-A-1 475 228, EP-A-1 475 229, EP-A-1 471 094 and EP-A-1 471 098 describe heat-sealable polyester films which are peelable with respect to A/CPET and have ABC structure, and which comprise, in order to establish the desired peel properties in the peelable and heat-sealable outer layer A, amorphous aromatic and aliphatic copolyesters and either from about 2 to 10% by weight of inorganic or organic particles or else a polymer incompatible with polyester, e.g. norbornene/ethylene. The films feature good peel properties with respect to polar substrates, such as PET or PVC, but they are not sealable with respect to PS and PP.

### SUMMARY OF ADVANTAGEOUS EMBODIMENTS OF THE INVENTION

In was an object of the present invention to provide a coextruded, heat-sealable, and peelable, biaxially oriented polyester film which features excellent peel properties with respect to nonpolar substrates, such as polystyrene (“PS”) or polypropylene (“PP”). It is intended to eliminate the disadvantages of the films of the prior art and in particular to feature the following combinations of properties:
It should be peelable with respect to PS and PP, and this means that the peel force is intended to be greater than or equal to 1 N per 15 mm of film strip width, preferably to be greater than or equal to 1.5 N per 15 mm of film strip width, and particularly preferably to be greater than or equal to 2 N per 15 mm of film strip width (based on a 30 μm film).
The peelable layer should be heat-sealable with respect to PS and PP, i.e. to have a minimum sealing temperature below or equal to 150° C., preferably below or equal to 140° C., in particular below or equal to 130° C. (based on a 30 μm film).
The film should be capable of cost-effective production. This means, for example, that stretching processes conventional in industry can be used for the production of the film. The film is moreover intended to be capable of production at the machine speeds of up to 500 m/min which are conventional nowadays, and moreover to be regrindable (recyclable).
For practical application of the film, a further intention is that it has good adhesion (greater than 2 N/15 mm of film width) between its individual layers, without application of any additional adhesive.

Heat-sealable here means that property of a coextruded polyester film comprising at least one outer layer (=heat-sealable outer layer (A)) that allows it to be bonded by means of sealing jaws via application of heat (from 130 to 220° C.) and pressure (from 2 to 5 bar) within a certain time (from 0.2 to 2 s) to itself (fin sealing) or to a substrate comprised of thermoplastic (in particular here PS and PP), while the backing layer (=base layer (B)) does not itself become plastic during this process.

Peelable here means that property of a coextruded polyester film comprising at least one outer layer (=heat-sealable and peelable outer layer (A)) that allows it, after heat-sealing to a substrate (in essence here PS and PP), to be peeled away again from the substrate in such a way that no tearing or break-off of the film occurs during this process. When the film is peeled from the substrate, the composite comprised of heat-sealable film and substrate should part in the seam between the heat-sealable layer and the substrate surface.

### DETAILED DESCRIPTION OF ADVANTAGEOUS EMBODIMENTS OF THE INVENTION

The foregoing objects are achieved via provision of a coextruded, biaxially oriented polyester film, comprising a base layer (B) and a heat-sealable outer layer (A) peelable with respect to polystyrene (“PS”) and polypropylene (“PP”), where the heat-sealable and peelable outer layer (A) is mainly comprised of a composition comprised of
from 30 to 100% by weight of ethylene-acrylate copolymer and
from 0 to 70% by weight of polyester,
   where the ethylene-acrylate copolymer contains from 10 to 40 mol % of acrylate.

When molar percentages are stated in the polymer or copolymer, they are based—unless otherwise stated—on the units derived from the monomer mentioned in the polymer or copolymer. The same applies to the description of the structure of the polymers and copolymers themselves.

The heat-sealable and peelable outer layer (A) has characteristic features. It has a minimum sealing temperature of not more than 150° C. with respect to PS and PP, preferably not more than 140° C., and particularly preferably not more than 130° C., and a seal seam strength of at least 1 N with respect to PS and PP, preferably at least 1.5 N, and particularly preferably at least 2 N (always based on 15 mm of film width and a 30 μm film). The maximum sealing temperature of the heat-sealable and peelable outer layer (A) with respect to PS and PP is generally 220° C., and in the entire sealing range (minimum sealing temperature to maximum sealing temperature) a film which is peelable with respect to PS and PP is obtained here.

The film of the present invention comprises a base layer (B) and at least one outer layer (A) of the invention. In this case, the film has a two-layer structure. In one preferred embodiment, the film is comprised of three or more layers. In the case of the particularly preferred three-layer embodiment, it is then comprised of the base layer (B), of the outer layer (A) of the invention, and of an outer layer (C) opposite to the outer layer (A). In the case of a four-layer embodiment, the film comprises an intermediate layer (D) between the base layer (B) and the outer layer (A) or (C).

The base layer of the film is comprised of at least 80% by weight of thermoplastic polyester. Polyesters suitable for this purpose are those comprised of ethylene glycol and terephthalic acid (=polyethylene terephthalate, PET), of ethylene glycol and naphthalene-2,6-dicarboxylic acid (=polyethylene 2,6-naphthalate, PEN), of 1,4-bishydroxymethylcyclohexane and terephthalic acid (=poly-1,4-cyclohexane-dimethylene terephthalate, PCDT), and also of ethylene glycol, naphthalene-2,6-dicarboxylic acid, and biphenyl-4,4′-dicarboxylic acid (=polyethylene 2,6-naphthalate bibenzoate, PENBB). Preference is given to polyesters which contain ethylene units and which—based on the dicarboxylate units—are comprised of at least 90 mol %, particularly preferably at least 95 mol %, of terephthalate units or 2,6-naphthalate units. The remaining monomer units derive from other dicarboxylic acids and, respectively, diols. For the base layer (B), it is also possible and advantageous to use copolymers or mixtures or blends comprised of the homo- and/or copolymers mentioned. In the data for the amounts of the dicarboxylic acids, the total amount of all of the dicarboxylic acids is 100 mol %. By analogy, the total amount of all of the diols is also 100 mol %.

Preferred suitable other aromatic dicarboxylic acids are benzenedicarboxylic acids, naphthalenedicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid), or stilbene-x,x′-dicarboxylic acids. Among the cycloaliphatic dicarboxylic acids, mention may be made of cyclohexanedicarboxylic acids (in particular cyclohexane-1,4-dicarboxylic acid). Among the aliphatic dicarboxylic acids, the (C₃-C₁₉)-alkanediacids are particularly suitable, where the alkane moiety can be straight-chain or branched.

Examples of suitable other aliphatic diols are diethylene glycol, triethylene glycol, aliphatic glycols of the general formula HO—(CH₂)ₙ—OH, where n is a whole number from 3 to 6 (in particular propane-1,3-diol, butane-1,4-diol, pentane-1,5-diol, and hexane-1,6-diol), or branched aliphatic glycols having up to 6 carbon atoms, or cycloaliphatic diols which have one or more rings and which, if appropriate, contain heteroatoms. Among the cycloaliphatic diols, mention may be made of cyclohexanediols (in particular cyclohexane-1,4-diol). Suitable other aromatic diols correspond by way of example to the formula HO—C₆H₄—X—C₆H₄—OH, where X is —CH₂—, —C(CH₃)₂—, —O—, —S—, or —SO₂—. Biphenols of the formula HO—C₆H₄—C₆H₄—OH also have good suitability.

It is moreover advantageous when the base layer (B) uses a polyester copolymer based on terephthalate and on small amounts (<3 mol %) of isophthalate, or based on terephthalate and on small amounts (<3 mol %) of naphthalate. In this case, the ease of production of the film and its optical properties are particularly good. The base layer (B) then in essence comprises a polyester copolymer comprised mainly of terephthalic acid and isophthalic acid units and/or terephthalic acid and naphthalene-2,6-dicarboxylic acid units, and of ethylene glycol units. The particularly preferred copolyesters which provide the desired properties of the film are those comprised of terephthalate units and of isophthalate units, and of ethylene glycol units.

The polyesters can be prepared by the transesterification process. This process starts from dicarboxylic esters and diols, which are reacted using the conventional transesterification catalysts, such as the salts of zinc, of calcium, of lithium, of magnesium, and of manganese. The intermediates are then polycondensed in the presence of well-known polycondensation catalysts, such as antimony trioxide, titanium oxides, or esters, or else germanium compounds and aluminum compounds. They can equally well be prepared by the direct esterification process in the presence of polycondensation catalysts. This process starts directly from the dicarboxylic acids and from the diols.

The film of the present invention has a structure of at least two layers. It is then comprised of the base layer (B) and of the sealable and peelable outer layer (A) of the invention applied thereto via coextrusion.

The sealable and peelable outer layer (A) applied via coextrusion to the base layer (B) is comprised of at least 30% by weight, preferably at least 40% by weight, and particularly preferably at least 50% by weight, of an ethylene-acrylate copolymer, where the ethylene-acrylate copolymer contains from 10 to 40 mol % of acrylate.

According to the invention, “acrylate” means a monomer unit which is comprised of an ethylene unit and of one or more polar groups pendant thereon. The copolymer is then comprised of “pure” units derived from ethylene and of units which derive from acrylate and which correspond to the formula

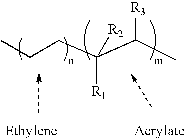

where

R₁ is C₁-C₃-alkoxycarbonyl or
—CO—OR₄, where
R₄ is hydrogen, linear or branched C₁-C₁₈-alkyl, which optionally is singularly, doubly, triply, or multiply substituted by OH or by phenyl,
   C₅-C₁₂-cycloalkyl, which optionally is bridged by a C₁-C₃ bridge, and/or which has single, double, or multiple substitution by lower alkyl,
   phenyl, or
   —(CH₂—CH₂—O)_{q}—R₅, where
   R₅ is hydrogen, C₁-C₂₄-alkyl, or phenyl, where the phenyl can be singularly, doubly, or multiply substituted by C₁-C₁₂-alkyl, and

R₂ and R₃ are hydrogen or lower alkyl.

Preference is given to copolymers in which

R₁ is methoxycarbonyl or
—CO—OR₄, where
R₄ is hydrogen, linear or branched C₁-C₁₈-alkyl, which optionally is singularly substituted by OH or by phenyl or triply substituted by OH, C₅-C₆-cycloalkyl, which, optionally, is bridged by a C₁ bridge and/or is substituted by lower alkyl,
   phenyl, or
   —(CH₂—CH₂—O)_{q}—R₅ where
   R₅ is hydrogen, methyl, C₂₂-alkyl, or phenyl, where the phenyl can be substituted by C₇-C₉-alkyl, and

R₂ is hydrogen or methyl.

“Lower alkyl” means a methyl, ethyl, propyl, isopropyl, butyl, isobutyl, or tert-butyl radical.

The proportion of acrylate-based repeat units in the ethylene-acrylate copolymer is from 12 to 50 mol %, preferably from 14 to 45 mol %, and particularly preferably from 16 to 40 mol %.

Examples of these polar “acrylic acid” monomers include:

vinyl acetate, acrylic acid, methacrylic acid, ethyl acrylate, ethyl methacrylate, methyl acrylate, methyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, n-hexyl acrylate, n-hexyl methacrylate, n-octyl acrylate, n-octyl methacrylate, 2-octyl acrylate, 2-octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, cyclohexyl acrylate, cyclohexyl methacrylate, benzyl acrylate, benzyl methacrylate, phenyl acrylate, phenyl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol)4-nonylphenyl ether acrylate, poly(ethylene glycol)4-nonylphenyl ether methacrylate, poly(ethylene glycol)phenyl ether acrylate, poly(ethylene glycol)phenyl ether methacrylate, preference being given to those which comprise vinyl acetate, acrylic acid, methacrylic acid, alkyl(meth)acrylate, or a combination of two or more thereof.

The ethylene-acrylic acid copolymers used according to the invention are either commercially available per se or can easily be prepared—by processes familiar to the person skilled in the art—for example via the processes described in WO 06/055656.

The sealable and peelable outer layer (A) can comprise, alongside the ethylene-acrylate copolymer, up to 70% by weight, preferably up to 60% by weight, and particularly preferably up to 50% by weight, of polyester. The lower limit for the polyester is advantageously greater than or equal to 0% by weight, preferably greater than or equal to 2% by weight, and particularly preferably greater than or equal to 4% by weight.

For the polyester in the sealable/peel layer it is generally possible to select the polyester described above for the base. In this case, the polyester is usually selected from the group of PET, polyethylene isophthalate (IPA), and mixtures thereof.

It has proven particularly advantageous to use a polyester substantially based on copolyesters mainly comprised of isophthalic acid units and terephthalic acid units and of ethylene glycol units. The remaining monomer units derive from the other aliphatic, cycloaliphatic, or aromatic diols and, respectively, dicarboxylic acids which can also occur in the base layer. The preferred copolyesters which provide the desired sealing properties are those comprised of ethylene terephthalate units and ethylene isophthalate units and of ethylene glycol units.

The addition of polyester to the sealable and peelable outer layer (A) improves the ease of production of the film, and this means, for example, that the tendency of the film to adhere to metallic rolls is reduced, and that the adhesion of the outer layer (A) to the base layer (B) is improved.

The outer layer (A) is comprised mainly of the polymers described. “Mainly” means that it is comprised of at least 90% by weight of these polymers. Up to 10% by weight of additives can be present in this layer.

The heat-sealable and peelable outer layer (A) also optionally comprises, as additive, inorganic and/or organic particles (also termed “pigments” or “antiblocking agents”) at a concentration of from 0 to 10% by weight, based on the weight of the outer layer (A). In one preferred embodiment, the outer layer (A) comprises inorganic and/or organic particles at a concentration of from 0.1 to 9% by weight, based on the weight of the outer layer (A). In one particularly preferred embodiment, the outer layer (A) comprises inorganic and/or organic particles at a concentration of from 0.5 to 8% by weight, based on the weight of the outer layer (A).

Examples of conventional particles are calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, the calcium, barium, zinc, or manganese salts of the dicarboxylic acids used, titanium dioxide, kaolin, or crosslinked polystyrene particles, or crosslinked acrylate particles. The particles can be added to the layer in the respectively advantageous concentrations, e.g. in the form of a glycolic dispersion during the polycondensation reaction, or by way of masterbatches during the extrusion process.

According to the invention, preferred particles are synthetically prepared, amorphous SiO₂ particles in colloidal form. These particles give excellent bonding into the polymer matrix and produce only few vacuoles (cavities). Vacuoles are produced at the particles during the biaxial orientation process, and generally cause haze and are therefore not very suitable for the present invention. Suitable particles can be purchased, for example, from the companies Grace, Fuji, Degussa, or Ineos. The median particle diameter d₅₀ is generally from 2.0 to 15 μm.

In order to achieve a further improvement in the processing performance of the film of the present invention, it is advantageous that particles are likewise incorporated into the base layer (B) in the case of a two-layer film structure (AB) and, respectively, into the outer layer (C) in the case of a three-layer film structure (ABC).

In the case of the two-layer embodiments of the film of the invention, and in the case of its particularly advantageous three-layer embodiment, the thickness of the outer layer (A) is in the range from 1 to 20 μm, preferably in the range from 2 to 18 μm, and particularly preferably in the range from 3 to 15 μm. If, however, the thickness of the outer layer (A) is less than 1 μm, the film is no longer heat-sealable.

The thickness of the other outer layer (C) can be the same as that of the outer layer (A) or different therefrom; its thickness is generally from 1 to 20 μm.

The total thickness of the polyester film of the invention can vary within certain limits. It is from 10 to 200 μm, in particular from 15 to 150 μm, preferably from 20 to 100 μm, the proportion of the total thickness made up by the layer (B) preferably being from 45 to 97%.

In one preferred embodiment, the base layer (B) comprises at least one whitening pigment at a concentration of from 3 to 20%, preferably from 4 to 18%. According to the invention, this concentration is selected in such a way that the (Berger) whiteness of the film is greater than 70. Otherwise, the optical properties of the film are not very suitable for the intended applications (e.g. sealed lid film on pots), because the film is too translucent.

In order to achieve the abovementioned properties, in particular the desired whiteness of the film, the necessary pigments are incorporated into the base layer (B) and into the outer layer (C). Examples of those that can be used are titanium dioxide, calcium carbonate, barium sulfate, zinc sulfide, or zinc oxide. TiO₂ is preferably used as sole colorant pigment. It is preferably added in the form of extruded masterbatch (in which the concentration of titanium dioxide is markedly higher than in the biaxially oriented film) to the original polymer. A typical value for TiO₂ concentration in the extruded masterbatch is 50% by weight of titanium dioxide. The titanium dioxide can be either of rutile type or else of anatase type. It is preferable to use titanium dioxide of rutile type. The grain size of the titanium dioxide is generally from 0.05 to 0.5 μm, preferably from 0.1 to 0.3 μm. The incorporated pigments give the film a brilliant white appearance. In order to achieve the desired whiteness (>70) and the desired low transparency (<50%), the base layer (B) should have a high filler level. The particle concentration for achievement of the desired low transparency is greater than or equal to 3% by weight, but smaller than or equal to 20% by weight, preferably above 4% by weight, but below 18% by weight, based on the total weight of the base layer (B).

For a further increase in whiteness, suitable optical brighteners can be added to the base layer and/or to the other layers. Examples of suitable optical brighteners are HOSTALUX® KS (Clariant, Del.) or EASTOBRITE® OB-1 (Eastman, USA).

It has been found that the preferred use of in essence TiO₂ as colorant pigments makes the film less susceptible to tearing and delamination. Addition of the TiO₂, preferably by way of masterbatch technology, has the advantage that color differences, for example those due to inconsistent regrind properties, can be corrected relatively easily. If TiO₂ is used as sole pigment, the film becomes particularly smooth and thus more glossy, but may possibly have a tendency toward blocking.

The base layer and the other layers can also comprise conventional additives, such as stabilizers (UV, hydrolysis), and flame-retardant substances, or fillers. They are advantageously added to the polymer or the polymer mixture before the melting process begins.

The invention also provides a process for the production of the polyester film of the invention by extrusion processes known per se from the literature (“Handbook of Thermoplastic Polyesters, ed. S. Fakirov, Wiley-VCH, 2002” or in the chapter “Polyesters, Films” in “Encyclopedia of Polymer Science and Engineering, vol. 12, John Wiley & Sons, 1988”).

The procedure for the purposes of said process is that the melt corresponding to the film is extruded through a flat-film die, the resultant film is drawn off on one or more rolls for solidification, and the film is then biaxially stretched (oriented), and the biaxially stretched film is heat-set and, if appropriate, also corona- or flame-treated on the surface layer intended for treatment.

The polymer or the polymer mixtures for the individual layers of the film are first, as conventional in the extrusion process, compressed and plasticized in an extruder, and any additives provided as additions here can by this stage be present in the polymer or in the polymer mixture. The melt is then simultaneously forced through a flat-film die, and the extruded melt is drawn off on one or more cooled take-off rolls, whereupon the melt cools and solidifies to give a multilayer prefilm.

The biaxial stretching process is generally carried out sequentially. For this, the prefilm is preferably first stretched longitudinally (i.e. in machine direction=MD), and then stretched transversely (i.e. perpendicularly to the machine direction=TD). This leads to spatial orientation of the polymer chains. The longitudinal stretching process can be carried out with the aid of two rolls rotating at different speeds corresponding to the stretching ratio desired. For the transverse stretching process, an appropriate tenter frame is generally used, in which the film is clamped at both edges and is then drawn toward the two sides at elevated temperature.

The temperature at which the stretching process is carried out can vary relatively widely and depends on the desired properties of the film. The longitudinal stretching process is generally carried out at a temperature in the range from 60 to 130° C. (heating temperatures from 60 to 130° C., stretching temperatures from 60 to 130° C.), and the transverse stretching process is generally carried out within the temperature range from 90° C. (start of stretching) to 140° C. (end of stretching). The longitudinal stretching ratio is generally in the range from 2.0:1 to 5:1, preferably from 2.5:1 to 4.5:1. The transverse stretching ratio is generally in the range from 3.0:1 to 5.0:1, preferably from 3.5:1 to 4.5:1.

In the heat-setting process which follows, the film is kept for a period of from about 0.1 to 10 s at a temperature in the range from 150 to 250° C. The film is then wound up in the usual way.

After the biaxial stretching process, the side opposite of the sealable side of the film can be corona- or flame-treated by one of the known methods. The intensity of treatment is adjusted so as to give a surface tension in the range above 45 mN/m.

The film can also be coated in order to establish other desired properties. Typical coatings have adhesion-promoting, antistatic, slip-improving, hydrophilic, or release effect. These additional layers can of course be applied to the film by way of in-line coating by means of aqueous dispersions after the longitudinal stretching step and prior to the transverse stretching step.

The gloss of the film surface (B) in the case of a two-layer film, or the gloss of the film surface (C) in the case of a three-layer film, is greater than 40. In one preferred embodiment, the gloss of these sides is more than 50, and in one particularly preferred embodiment is more than 60 (measured to DIN 67530 by a method based on ASTM D523-78 and ISO 2813 using an angle of incidence of 20°). These film surfaces are therefore particularly suitable for a further functional coating, or for printing, or for metalizing.

The film of the invention has excellent suitability for the packaging of foods and of other consumable items, in particular for the packaging of dairy products in pots, where peelable polyester films are used for opening the package.

The table below (table 1) once again summarizes the most important film properties of the invention:

TABLE 1

| | | | Very | | |
|---|---|---|---|---|---|
| | Preferred | Particularly | particularly | | |
| | range | preferred | preferred | Unit | Test method |
| Outer layer (A) | | | | | |
| Proportion of ethylene- | | from 40 to 98 | from 50 to 96 | % by wt. | |
| acrylate copolymer | | | | | |
| Proportion of polyester | from 0 to 70 | from 2 to 60 | from 4 to 50 | % by wt. | |
| Proportion of acrylate in | from 10 to 40 | from 15 to 35 | from 20 to 30 | mol % | |
| copolymer | | | | | |
| Thickness d_{A} of outer layer | from 1 to 20 | from 2 to 18 | from 3 to 15 | μm | |
| (A) | | | | | |
| Properties | | | | | |
| Thickness of film | from 10 to 200 | from 15 to 150 | from 20 to 100 | | |
| Minimum sealing temperature | 150 | 140 | 130 | ° C. | internal |
| of OL (A) with respect to PS | | | | | |
| and PP (for a 30 μm film) | | | | | |
| Seal seam strength of OL (A) | ≧1.0 | ≧1.5 | ≧2.0 | N/15 mm | internal |
| with respect to PS and PP | | | | | |
| (for a 30 μm film) | | | | | |

OL: outer layer

For the purposes of the present invention, the following test methods were used to characterize the raw materials and the films:

Measurement of Median Diameter d₅₀

The median diameter d₅₀ of the antiblocking agent is determined by means of a laser, using laser scanning on a Malvern Mastersizer (an example of other test equipment being the Horiba LA 500 or Sympathec Helos, using the same principle of measurement). For the tests, the specimens are placed with water in a cell, and this is then placed in the test equipment. A laser scans the dispersion and the particle size distribution is determined from the signal via comparison with a calibration curve. The test procedure is automatic and also includes mathematical determination of the d₅₀ value. The d₅₀ value here is defined as being determined as follows from the “relative” cumulative particle size distribution curve: the desired d₅₀ is directly given on the abscissa axis by the intersection of the 50% ordinate value (also termed median) with the cumulative curve.

SV Value

The SV value of the polymer is determined via measurement of relative viscosity (ηrel) of a 1% strength solution in dichloroacetic acid in an Ubbelohde viscosimeter at 25° C. The SV value is defined as follows:

SV=(ηᵣₑₗ−1)*1000.

Seal Seam Strength

To determine seal seam strength, a film strip (length 100 mm×width 15 mm) is placed on an appropriate substrate (PS or PP) and sealed at the set temperature of ≧130° C., using a sealing time at 0.5 s and a sealing pressure of 3 bar (HSG/ET sealing equipment from Brugger, double-side heated sealing jaws). The sealed strips are pulled apart at an angle of 180°, and the force needed is determined, using a peel speed of 200 mm/min. Seal seam strength is stated in N per 15 mm of film strip (e.g. 3 N/15 mm).

Determination of Minimum Sealing Temperature

Heat-sealed specimens (seal seam 15 mm×100 mm) were produced with the HSG/ET sealing equipment from Brugger, as described above for measurement of seal seam strength, but the film is sealed at various temperatures with the aid of two heated sealing jaws at a sealing pressure of 3 bar, for a sealing time of 0.5 s. 180° seal seam strength is measured as in the determination of seal seam strength. The minimum sealing temperature is the temperature at which a seal seam strength of at least 0.5 N/15 mm is achieved.

Haze

Hölz haze is determined to ASTM D1003-52.

Gloss

Gloss of the film is determined to DIN 67530. The reflectance value is measured, this being a characteristic optical value for a film surface. Based on the standards ASTM D523-78 and ISO 2813, the angle of incidence is set at 20°. A beam of light at the set angle of incidence hits the flat test surface and is reflected and/or scattered thereby. A proportional electrical variable is displayed representing light rays hitting the photoelectric detector. The value measured is dimensionless and must be stated together with the angle of incidence.

Whiteness

Whiteness is determined by the Berger method, the general method being that more than 20 layers of film are mutually superposed. Whiteness is determined with the aid of an ELREPHO® electrical reflectance photometer from Zeiss, Oberkochem (DE), standard illuminant C, 2° standard observer. Whiteness is defined as

WG=RY+3RX−3RX

WG=whiteness, and RY, RZ, and RX=corresponding reflection factors using the Y, Z, and X color-measurement filter. The whiteness standard used is a barium sulfate pressing (DIN 5033, part 9). A detailed description is given by way of example in Hansl Loos “Farbmessung” [Color measurement], Verlag Beruf und Schule, Itzehoe (1989).

Melt Index

Melt index is measured to DIN 537354.

An inventive example is used below for further illustration of the invention.

### EXAMPLE 1

Chips comprised of polyethylene terephthalate were fed to the extruder for the base layer (B). Chips comprised of polyethylene terephthalate and particles were likewise fed to the extruder (twin-screw extruder) for the outer layer (C). The raw materials were melted and homogenized in the two respective extruders in accordance with the process conditions listed in the table below.

Alongside this, an ethylene-methyl acrylate copolymer (LOTRYL® 24 MA07 from Arkema, Del.) was fed to a twin-screw extruder with vent(s), for the sealable and peelable outer layer (A). The raw material was melted in the twin-screw extruder in accordance with the process conditions stated in the table below.

Coextrusion in a three-layer die was then used to superpose the three layers of melt steam on one another and to discharge them over the die lip. The resultant melt film was cooled and then a transparent, three-layer film with ABC structure was produced at a total thickness of 30 μm by way of stepwise longitudinal and transverse orientation and subsequent setting. The thickness of the outer layer (A) is 4 μm, and the thickness of the outer layer (C) is 2 μm.

Outer layer (A)

| | |
|---|---|
| 100% by weight | of ethylene-methyl acrylate |
| | copolymer (LOTRYL ® 24 MA07 from |
| | Arkema, DE) having a proportion of |
| | 24 mol % of methyl acrylate and a |
| | melt index of 7 g/10 min |

Base layer (B)

| | |
|---|---|
| 100% by weight | of polyethylene terephthalate with |
| | SV value of 800 |

Outer layer (C), a mixture comprised of

| | |
|---|---|
| 85% by weight | of polyethylene terephthalate with |
| | SV value of 800 |
| 15% by weight | of masterbatch comprised of 99% by |
| | weight of polyethylene |
| | terephthalate (SV value of 800) and |
| | 1.0% by weight of SYLOBLOC ® 44 H |
| | (synthetic SiO₂, Grace, Worms, DE), |
| | d₅₀ = 2.5 μm |

The production conditions in the individual steps of the process were:

| | | | | |
|---|---|---|---|---|
| Extrusion | Temperatures | Layer A: | 280 | ° C. |
| | | Layer B: | 280 | ° C. |
| | | Layer C: | 280 | ° C. |
| | Take-off roll | | 20 | ° C. |
| | temperature | | | |
| Longitudinal | Heating | | 70-110 | ° C. |
| stretching | temperature | | | |
| | Stretching | | 105 | ° C. |
| | temperature | | | |
| | Longitudinal | | 3.6 | |
| | stretching ratio | | | |
| Transverse | Heating | | 105 | ° C. |
| stretching | temperature | | | |
| | Stretching | | 135 | ° C. |
| | temperature | | | |
| | Transverse | | 4.0 | |
| | stretching ratio | | | |
| Setting | Temperature | | 230 | ° C. |
| | Duration | | 3 | s |

The minimum sealing temperatures and the seal seam strengths measured for the film with respect to PS and PP have been entered in table 2. For the test of seal seam strength, the film was sealed at 180° C. with respect to PS and PP (sealing pressure 3 bar, sealing time 0.5 s). Strips of the composite comprised of film of the invention and substrate were then pulled apart in accordance with the abovementioned test specification. In each case, the films were found to peel as desired from the substrate.

TABLE 2

| | PS | PP | Unit |
|---|---|---|---|
| Minimum sealing temperatures | 102 | 104 | ° C. |
| Seal seam strength | 2.8 | 2.5 | N/15 mm |

### COMPARATIVE EXAMPLE 1

Example 1 from EP-A-1 475 228 was repeated. The film was found to give peelable sealing with respect to PET, but not with respect to PS and PP. The film did not seal with respect to these materials.

That which is claimed:

1. A multilayer, coextruded, biaxially oriented, sealable polyester film comprising a base layer (B) and a heat-sealable outer layer (A) peelable with respect to polystyrene (PS) and polypropylene (PP), where the heat-sealable and peelable outer layer (A) mainly comprises a composition comprised of
a) from 30 to 100% by weight of ethylene-acrylate copolymer and
b) from 0 to 70% by weight of polyester, and
where the ethylene-acrylate copolymer contains from 10 to 40 mol % of acrylate.

2. The polyester film as claimed in claim 1, wherein the base layer (B) comprises a thermoplastic polyester.

3. The polyester film as claimed in claim 2, wherein the polyester of the base layer (B) comprises at least 90 mol % of ethylene glycol units and terephthalic acid units or ethylene glycol units and naphthalene-2,6-dicarboxylic acid units.

4. The polyester film as claimed in claim 2, wherein the polyester of the base layer (B) comprises polyethylene terephthalate.

5. The polyester film as claimed in claim 1, wherein, in the sealable outer layer (A), the proportion of ethylene-acrylic acid copolymer is from 50 to 96% by weight and the proportion of polyester is from 4 to 50% by weight.

6. The polyester film as claimed in claim 1, wherein the sealable outer layer (A) further comprises SiO₂ particles as pigment.

7. The polyester film as claimed in claim 1, wherein the thickness of the sealable outer layer (A) is from 1.0 to 20 μm.

8. The polyester film as claimed in claim 1, wherein the minimum sealing temperature of the sealable outer layer (A) with respect to PS and PP is 150° C. or lower.

9. A process for the production of a coextruded polyester film as claimed in claim 1, comprising the steps of
a) producing a multilayer film by coextrusion,
b) biaxially stretching the coextruded film, and
c) heat-setting the biaxially stretched film,
wherein the polyester film comprises a base layer and at least one heat-sealable and peelable outer layer (A), and the heat-sealable and peelable outer layer (A) mainly comprises a composition comprised of from 30 to 100% by weight of ethylene-acrylate copolymer and from 0 to 70% by weight of polyester, with the ethylene-acrylate copolymer containing from 10 to 40 mol % of acrylate.

10. Food or other consumable item packaging comprising a film as claimed in claim 1.

11. Food or other consumable item packaging comprising a film as claimed in claim 10, wherein the food packaging is packaging for dairy products in pots.
